(19) United States
(12) Patent Application Publication
(10) Pub. No.: US 2021/0012237 A1
(43) Pub. Date: Jan. 14, 2021

(54) DE-IDENTIFYING MACHINE LEARNING MODELS TRAINED ON SENSITIVE DATA

(71) Applicant: INTERNATIONAL BUSINESS MACHINES CORPORATION, Armonk, NY (US)

(72) Inventors: Pathirage Dinindu Sujan Udayanga Perera, San Jose, CA (US); Sheng Hua Bao, San Jose, CA (US); Ramani Routray, San Jose, CA (US); Sundari Voruganti, San Jose, CA (US); Pratima Virkar, Morrisville, NC (US)

(21) Appl. No.: 16/508,456

(22) Filed: Jul. 11, 2019

(51) Int. Cl. G06N 20/00; G06F 17/27

(52) U.S. Cl. CPC G06N 20/00; G06F 17/2785; G06F 17/2705

(57) ABSTRACT

A method, computer system, and a computer program product for de-identifying at least one machine learning (ML) model trained utilizing a set of sensitive data is provided. The present invention may include receiving a corpus of documents. The present invention may then include creating at least one terms list from the received corpus of documents. The present invention may further include de-identifying the at least one ML model based on the created at least one terms list.

### BACKGROUND

The present invention relates generally to the field of computing, and more particularly to computational statistics.

One of the major challenges of training machine learning (ML) models is the lack of labelled training data. Hence, inventive ways to reuse existing trained ML models when applicable would be useful. However, certain restrictions on the data prevent the reuse of ML models regardless of the feasibility. One such restriction stems from the presence of sensitive information in the data. For example, some ML models may be trained using protected health information (PHI) data. As such, the inclusion of PHI data prevents the reuse of the ML models, outside the well-restricted environment.

### SUMMARY

Embodiments of the present invention disclose a method, computer system, and a computer program product for de-identifying at least one machine learning (ML) model trained utilizing a set of sensitive data. The present invention may include receiving a corpus of documents. The present invention may then include creating at least one terms list from the received corpus of documents. The present invention may further include de-identifying the at least one ML model based on the created at least one terms list.

### BRIEF DESCRIPTION THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for de-identifying ML models according to at least one embodiment;

FIG. 3 is an operational flowchart illustrating a process for generating and maintaining a terms list according to a least one embodiment;

FIG. 4 is a block diagram of internal and external components of computers and servers depicted in FIG. 1 according to at least one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language, Python programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for de-identifying ML models trained on sensitive data. As such, the present embodiment has the capacity to improve the technical field of computational statistics by removing sensitive data from trained ML models. More specifically, the present embodiment may create a terms list for vocabulary and de-identify the ML models by utilizing the created terms list to identify and remove sensitive information and/or data within the ML models.

As previously described, one of the major challenges to train machine learning models is the lack of labelled training data. Hence, it is crucial to invent ways to re-use existing trained models when applicable. However, certain restrictions on the data prevent the reuse of models although it is technically feasible. One such restriction is due to the presence of sensitive information in the data. For example, some models may be trained using PHI data, hence the artifacts of the training process contain PHI data which prevent the reuse of the models outside the well-restricted environment.

Therefore, it may be advantageous to, among other things, de-identify the ML models trained on PHI data using deep learning technology thereby enabling the ML models to be deployed outside of restricted environments and perform intended cognitive tasks on any other datasets and/or products.

Furthermore, the ML model de-identification program may utilize a cleaning process to remove sensitive information and/or data from the ML model to prepare the ML model for deployment in any other environment.

According to at least one embodiment, machine learning (ML) models trained using deep learning technology may save the vocabulary of the input data as an artifact. During a cleaning process, the ML model de-identification program may clean the ML model artifacts using pre-identified vocabulary, which may remove the sensitive information and/or data that may have been saved and/or stored with the ML model.

According to at least one embodiment, the ML model de-identification program may be divided into two parts: (1) creation of a terms list for vocabulary; and (2) de-identifying the ML models.

According to at least one embodiment, the ML model, utilized in the ML model de-identification program, may qualify to operate as a de-identified ML model by training with a special token that represents words and/or phrases (i.e., terms) that are absent or very infrequent in the initial dataset that the ML model is trained on. For example, in the training time, the ML model may add token “unknown” to represent the infrequent terms in the training dataset, which may be useful when the ML model de-identification program deletes or removes the sensitive data from the saved vocabulary since the deleted terms may be considered as “unknown” in the prediction time.

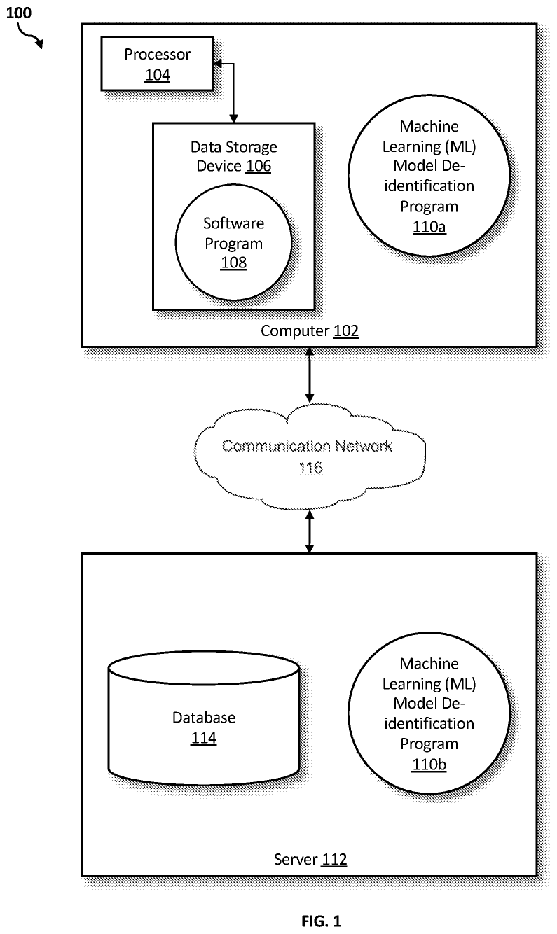

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a ML model de-identification program 110a. The networked computer environment 100 may also include a server 112 that is enabled to run a ML model de-identification program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

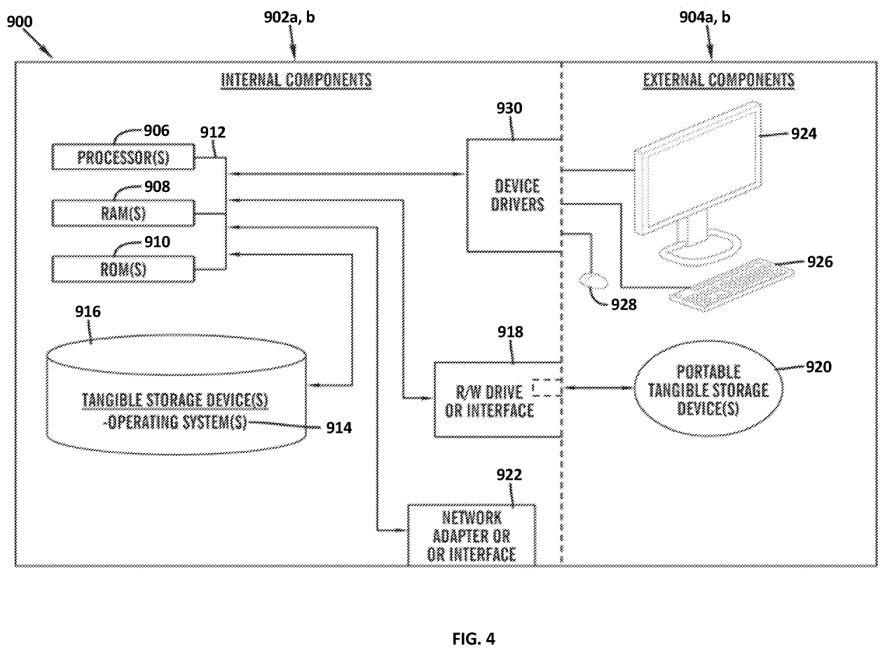

The client computer 102 may communicate with the server computer 112 via the communications network 116. The communications network 116 may include connections, such as wire, wireless communication links, or fiber optic cables. As will be discussed with reference to FIG. 4, server computer 112 may include internal components 902a and external components 904a, respectively, and client computer 102 may include internal components 902b and external components 904b, respectively. Server computer 112 may also operate in a cloud computing service model, such as Software as a Service (SaaS), Analytics as a Service (AaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the ML model de-identification program 110a, 110b may interact with a database 114 that may be embedded in various storage devices, such as, but not limited to a computer/mobile device 102, a networked server 112, or a cloud storage service.

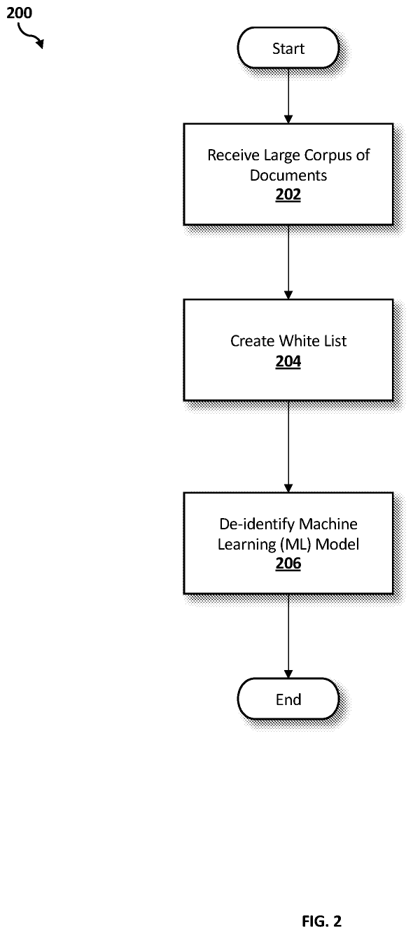

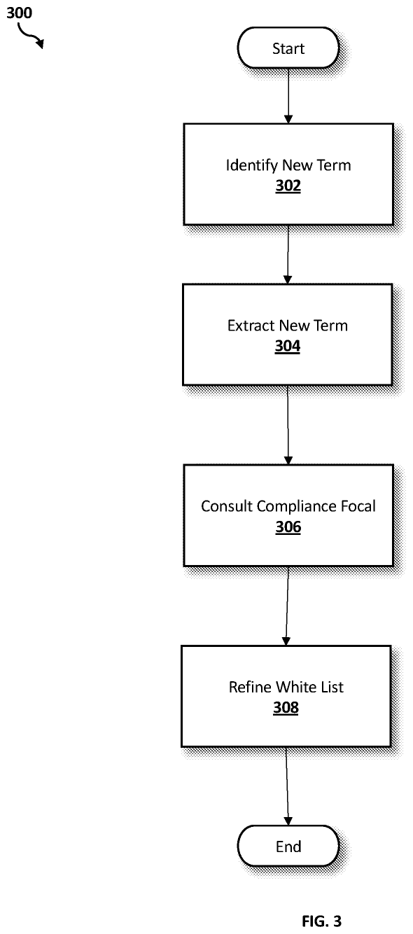

According to the present embodiment, a user using a client computer 102 or a server computer 112 may use the ML model de-identification program 110a, 110b (respectively) to de-identifying a machine learning (ML) model trained on sensitive data. The ML model de-identification method is explained in more detail below with respect to FIGS. 2 and 3.

Referring now to FIG. 2, an operational flowchart illustrating the exemplary ML model de-identification process 200 used by the ML model de-identification program 110a, 110b according to at least one embodiment is depicted.

At 202, a large corpus of documents is received. Utilizing the software program 108 on the user device (e.g., user's computer 102), a large corpus of documents may be transmitted as input into the ML model de-identification program 110a, 110b, via a communication network 116. The large corpus of documents may include publications, articles, social media posts, manuals, textbooks, reports and/or any other form of written materials associated with one or more particular subject matters. The large corpus of documents may be publicly available.

In at least one embodiment, the large corpus of documents may include unpublished documents or documents with limited access. However, regardless of whether the access to the large corpus of documents is limited or public, the large corpus of document may exclude sensitive information and/or data.

In some embodiments, the large corpus of documents may sorted based on subject matter. Therefore, the large corpus of documents transmitted, via the communication network 116, may include documents associated with a particular subject matter or domain.

In the present embodiment, the user may manually select the large corpus of documents based on the particular domain or subject matter, and may upload or transmit that particular large corpus of documents into the ML model de-identification program 110a, 110b via the communication network 116.

In one embodiment, the ML model de-identification program 110a, 110b may automatically select the particular large corpus of documents based on the topics of interest associated with the user. For example, if the user is a microbiologist, the ML model de-identification program 110a, 110b will automatically upload articles, publications and other written materials related to microbiology that the ML model de-identification program 110a, 110b may find at a previously determined and approved site or an authoritative source. The automatically selected written materials may be included in the large corpus of documents. In at least one embodiment, the user or an administrator may manually include a list of previously determined and approved sites for the ML model de-identification program 110a, 110b to monitor and include in the large corpus of documents.

In some embodiments, the ML model de-identification program 110a, 110b may utilize a monitoring module to monitor the sites visited by the user to determine whether the site is a previously determined and approved site. Before the site is included in a list of previously determined and approved sites, the ML model de-identification program 110a, 110b, via the monitoring module, may prompt (e.g., via a dialog box) the user as to whether the user wants to include the site in the list of previously determined and approved sites. If the user indicates negatively, then the site may not be included in the list of previously determined and approved sites. However, if the user indicates affirmatively, then the site may be included in the list of previously determined and approved sites.

In the present embodiment, the monitoring module may include an opt-in/opt-out feature in which the user may select to opt in or opt-out from the monitoring module. The opt-in/opt-out feature may be changed at any time, and if the user opts-in to the monitoring module, then the user may be notified when the monitoring module is activated and therefore monitoring the user's internet activity.

In at least one embodiment, the ML model de-identification program 110a, 110b may impose a size limit or restriction on the large corpus of documents. As such, the ML model de-identification program 110a, 110b may analyze the large corpus of documents to determine whether the size limit has been satisfied. In some embodiments, the ML model de-identification program 110a, 110b may notify and/or prompt a user (e.g., via a dialog box) if the size limit has been exceeded by the large corpus of documents. As such, the user may modify the file associated with the large corpus of documents to comply with the size limit without restricting the user from utilizing a particular corpus of documents.

For example, the user uploads fifteen different documents (over 100 pages) related to the internal medical records intake process at a local medical facility.

Next, at 204, a terms list is created. A terms list may be a list or compilation of data that includes a large corpus of terms (e.g., words, phrases) excluding any sensitive information and/or data (e.g., person names, age, social numbers, mailing address, email address, personal identifier). The ML model de-identification program 110a, 110b may manually create the terms list by identifying new terms from the large corpus of documents received by the ML model de-identification program 110a, 110b. Then, the ML model de-identification program 110a, 110b may utilize a compliance focal to analyze the new terms, and the terms list may be created and further refined based on the feedback provided by the compliance focal. The created and refined terms list may then be stored in a terms list repository 114 (e.g., database 114). A detailed operational flowchart of the terms list generation and maintenance process in the ML model de-identification program 110a, 110b will be described in greater detail below with respect to FIG. 3.

In at least one embodiment, the created terms list may be added to previously stored terms lists within the same subject matter or domain in the terms list repository 114. Therefore, the newly created terms list may be utilized to update the previously stored terms list within the same subject matter or domain. In some embodiments, the created terms list may be stored separately from any other previously stored terms lists and may utilized as the terms list for the received large corpus of documents.

Continuing the previous example, from the over 100 pages of documents, approximately 450 new terms are identified to create a terms list, and three of the terms were removed from the terms list since the three terms include personal identifiers that may be considered sensitive data.

Next, at 206, the ML model is de-identified. Utilizing the software program 108 on the user device (e.g., user's computer 102), the ML model de-identification program 110a, 110b may receive as input, via the communications network 116, a ML model from a user. One of the artifacts of a ML model, trained by utilizing deep learning technology, may be the vocabulary included in the trained ML model. Therefore, the ML model de-identification program 110a, 110b may then commence the cleaning process in which the ML model de-identification program 110a, 110b iterates through the created terms list and the saved terms (i.e., vocabulary or artifacts) within the ML model, and may remove any terms included in the received ML model that are excluded from the terms list. As such, since the created terms list excludes sensitive data or content, any sensitive data and/or content included in the ML model may be removed during the cleaning process. After the completion of the cleaning process, the ML model may be ready for deployment in any other environment.

Continuing the previous example, the terms included in the ML model and the created terms list from the large corpus of documents are compared. Any terms excluded from the created terms list from the large corpus of documents are removed from the ML model during the cleaning process.

Referring now to FIG. 3, an operational flowchart illustrating the exemplary terms list generation and maintenance process 300 used by the ML model de-identification program 110a, 110b according to at least one embodiment is depicted.

At 302, a new term is identified. The ML model de-identification program 110a, 110b may utilize a parsing module to parse through the large corpus of documents. A natural language processing (NLP) tokenizer (e.g., content categorization, topic discovery and modeling, contextual extraction, sentiment analysis, machine translation, document summarization) may then identify valid terms, which includes the words or phrases that appear in the large corpus of documents. In at least one embodiment, an identifying module may be utilized in which terms may be identified based on splitting by spaces.

Continuing the previous example, the terms “Jane”, “Doe” and “212-24-9851” were included among the 450 new terms identified by the NLP tokenizer.

Next, at 304, the new term is extracted. The ML model de-identification program 110a, 110b may then utilize an extractor module to extract the identified terms from the large corpus of documents. The extracted terms may be added to a list or compilation of terms in a terms list repository 114.

Continuing the previous example, the 450 new terms, including “Jane”, “Doe” and “212-24-9851”, were extracted by the extractor module.

Then, at 306, a compliance focal is consulted. The ML model de-identification program 110a, 110b may then consult a compliance focal (e.g., human intervention with expertise to determine the sensitivity of the terms included in the terms list) to examine the terms included in the terms list based on the sensitivity of the terms and/or the relevancy of the terms in the particular subject matter. The compliance focal may then provide feedback (e.g., whether a term should be rejected or approved) for inclusion of the term into a terms list. For example, the compliance focal identifies the inclusion of the phrase “a piece of cake” in the terms list. Since the subject matter involves the installation of a L-valve on a pipe and not the baking or serving of cake, the compliance focal determined that the phrase was used to show how easy a task was and possess minimal, if any, relation to the subject matter. Therefore, the compliance focal recommends that the phrase “a piece of cake” be removed from the terms list and excluded from the terms list.

Continuing the previous example, Compliance Focal A then reviews the 450 new terms, including “Jane”, “Doe” and “212-24-9851”. Since the terms, “Jane”, “Doe” and “212-234-9851”, may be considered personal identifiers as the name of a person and a social security number, Compliance Focal A identifies the three terms as sensitive data or invalid terms.

Then, at 308, the terms list is refined. The ML model de-identification program 110a, 110b may utilize the feedback provided by the compliance focal to refine the terms list. In at least one embodiment, the refined terms list may be sorted, by a sorting module, into the form of a list to create the terms list. In at least one embodiment, the terms list may be arranged in a list based on the most used or popular terms to the least popular terms included in the large corpus of documents.

Continuing the previous example, Compliance Focal A then provides feedback requesting that the three terms, “Jane”, “Doe” and “212-24-9851,” are removed from the terms list thereby refining the terms list to include valid terms excluding sensitive data.

The functionality of a computer may be improved by the ML model de-identification program 110a, 110b because the ML model de-identification program 110a, 110b may be utilized to create a terms list or list of appropriate terms, excluding sensitive data and/or information, and clean machine learning (ML) model artifacts (i.e., the vocabulary created for the ML model at the training time) based on the pre-identified terms within the created terms list. As such, instead of removing the sensitive data from the training data, the ML model de-identification program 110a, 110b may remove the sensitive data from the trained ML model. The ML model de-identification program 110a, 110b may allow for the use of the ML model after the training process by removing the sensitive data from the ML model and not only from the training data.

It may be appreciated that FIGS. 2 and 3 provide only an illustration of one embodiment and do not imply any limitations with regard to how different embodiments may be implemented. Many modifications to the depicted embodiment(s) may be made based on design and implementation requirements.

FIG. 4 is a block diagram 900 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 4. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the ML model de-identification program 110a in client computer 102, and the ML model de-identification program 110b in network server 112, may be stored on one or more computer-readable tangible storage devices 916 for execution by one or more processors 906 via one or more RAMs 908 (which typically include cache memory). In the embodiment illustrated in FIG. 4, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the ML model de-identification program 110a, 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the ML model de-identification program 110a in client computer 102 and the ML model de-identification program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the ML model de-identification program 110a in client computer 102 and the ML model de-identification program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

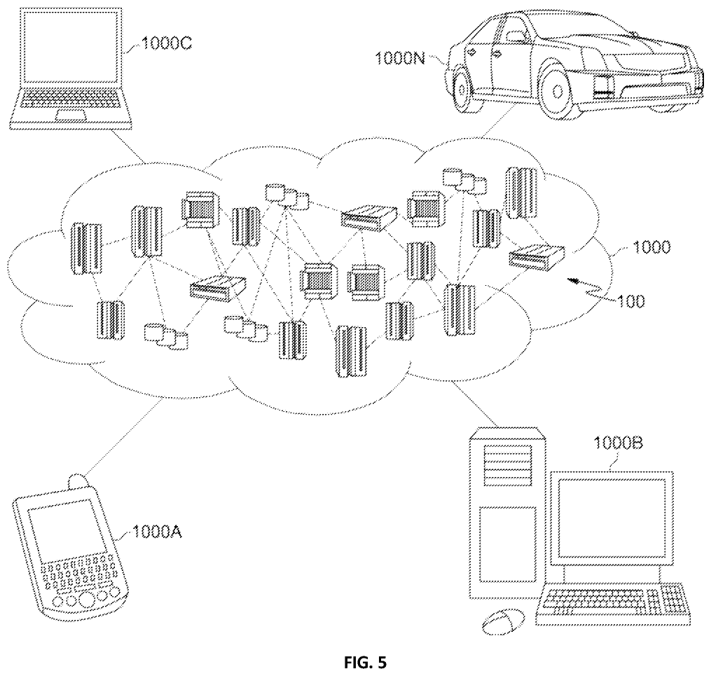

Referring now to FIG. 5, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 5 are intended to be illustrative only and that computing nodes 100 and cloud computing environment 1000 can communicate with any type of computerized device over any type of network and/or network addressable connection (e.g., using a web browser).

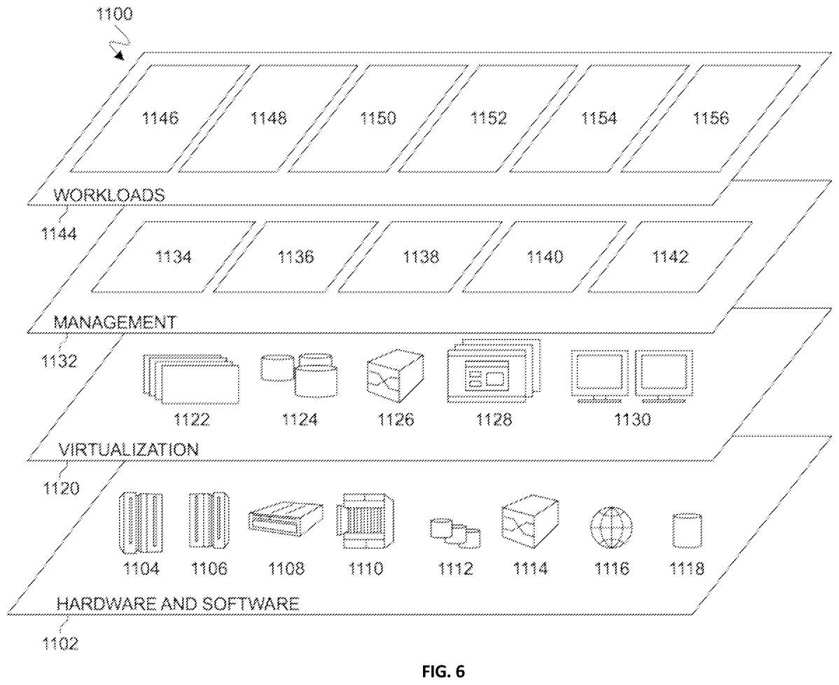

Referring now to FIG. 6, a set of functional abstraction layers 1100 provided by cloud computing environment 1000 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and ML model de-identification 1156. A ML model de-identification program 110a, 110b provides a way to de-identify at least one machine learning (ML) model trained on sensitive data.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for de-identifying at least one machine learning (ML) model trained utilizing a set of sensitive data, the method comprising:
receiving a corpus of documents;
creating at least one terms list from the received corpus of documents; and
de-identifying the at least one ML model based on the created at least one terms list.

2. The method of claim 1, wherein creating the at least one terms list, further comprises:
parsing the received corpus of documents;
identifying one or more new terms by utilizing natural language processing techniques, wherein the identified one or more terms includes a single word or a phrase;
extracting the identified one or more terms;
adding the extracted one or more terms to the created at least one terms list;
consulting one or more compliance focal on the extracted one or more terms; and
refining the created at least one terms list based on the consulted one or more compliance focal.

3. The method of claim 1, wherein de-identifying the at least one ML model based on the created at least one terms list, further comprises:
receiving the at least one ML model, wherein the received at least one ML model was trained by utilizing deep learning;
comparing one or more terms associated with the created at least one terms list with a plurality of artifacts associated with the received at least one ML model; and
removing one or more terms present in the received at least one ML model and absent in the created at least one terms list.

4. The method of claim 1, further comprising:
deploying the de-identified at least one ML model to one or more different environments.

5. The method of claim 2, wherein consulting the one or more compliance focal on the extracted one or more terms, further comprises:
examining the extracted one or more new terms associated with the created at least one terms list, wherein the extracted one or more new terms are examined based on a level of sensitivity associated with the extracted one or more new terms and a level of relevancy associated with the extracted one or more new terms; and
receiving a piece of feedback from the consulted one or more compliance focal associated with the level of sensitivity associated with the extracted one or more new terms and the level of relevancy associated with the extracted one or more new terms.

6. The method of claim 1, wherein the received corpus of documents includes publications, articles, social media posts, manuals, textbooks, reports or any other form of written materials associated with one or more particular subject matters.

7. The method of claim 1, wherein receiving the corpus of documents, further comprises:
selecting the corpus of documents based on one or more particular subject matters, wherein the selected corpus of documents excludes the set of sensitive data.

8. A computer system for de-identifying at least one machine learning (ML) model trained utilizing a set of sensitive data, comprising:
one or more processors, one or more computer-readable memories, one or more computer-readable tangible storage medium, and program instructions stored on at least one of the one or more tangible storage medium for execution by at least one of the one or more processors via at least one of the one or more memories further comprise program instructions to cause the computer system to perform a method comprising:
receiving a corpus of documents;
creating at least one terms list from the received corpus of documents; and
de-identifying the at least one ML model based on the created at least one terms list.

9. The computer system of claim 8, wherein creating the at least one terms list, further comprises:
parsing the received corpus of documents;
identifying one or more new terms by utilizing natural language processing techniques, wherein the identified one or more terms includes a single word or a phrase;
extracting the identified one or more terms;
adding the extracted one or more terms to the created at least one terms list;
consulting one or more compliance focal on the extracted one or more terms; and
refining the created at least one terms list based on the consulted one or more compliance focal.

10. The computer system of claim 8, wherein de-identifying the at least one ML model based on the created at least one terms list, further comprises:
receiving the at least one ML model, wherein the received at least one ML model was trained by utilizing deep learning;
comparing one or more terms associated with the created at least one terms list with a plurality of artifacts associated with the received at least one ML model; and
removing one or more terms present in the received at least one ML model and absent in the created at least one terms list.

11. The computer system of claim 8, further comprising:
deploying the de-identified at least one ML model to one or more different environments.

12. The computer system of claim 9, wherein consulting the one or more compliance focal on the extracted one or more terms, further comprises:
examining the extracted one or more new terms associated with the created at least one terms list, wherein the extracted one or more new terms are examined based on a level of sensitivity associated with the extracted one or more new terms and a level of relevancy associated with the extracted one or more new terms; and
receiving a piece of feedback from the consulted one or more compliance focal associated with the level of sensitivity associated with the extracted one or more new terms and the level of relevancy associated with the extracted one or more new terms.

13. The computer system of claim 8, wherein the received corpus of documents includes publications, articles, social media posts, manuals, textbooks, reports or any other form of written materials associated with one or more particular subject matters.

14. The computer system of claim 8, wherein receiving the corpus of documents, further comprises:
selecting the corpus of documents based on one or more particular subject matters, wherein the selected corpus of documents excludes the set of sensitive data.

15. A computer program product for de-identifying at least one machine learning (ML) model trained utilizing a set of sensitive data, the computer program product comprising a computer readable storage medium having program instructions embodied therewith, the program instructions executable by processor to cause the computer to perform the method comprising:
receiving a corpus of documents;
creating at least one terms list from the received corpus of documents; and
de-identifying the at least one ML model based on the created at least one terms list.

16. The computer program product of claim 15, wherein creating the at least one terms list, further comprises:
parsing the received corpus of documents;
identifying one or more new terms by utilizing natural language processing techniques, wherein the identified one or more terms includes a single word or a phrase;
extracting the identified one or more terms;
adding the extracted one or more terms to the created at least one terms list;
consulting one or more compliance focal on the extracted one or more terms; and
refining the created at least one terms list based on the consulted one or more compliance focal.

17. The computer program product of claim 15, wherein de-identifying the at least one ML model based on the created at least one terms list, further comprises:
receiving the at least one ML model, wherein the received at least one ML model was trained by utilizing deep learning;
comparing one or more terms associated with the created at least one terms list with a plurality of artifacts associated with the received at least one ML model; and
removing one or more terms present in the received at least one ML model and absent in the created at least one terms list.

18. The computer program product of claim 15, further comprising:
deploying the de-identified at least one ML model to one or more different environments.

19. The computer program product of claim 16, wherein consulting the one or more compliance focal on the extracted one or more terms, further comprises:
examining the extracted one or more new terms associated with the created at least one terms list, wherein the extracted one or more new terms are examined based on a level of sensitivity associated with the extracted one or more new terms and a level of relevancy associated with the extracted one or more new terms; and
receiving a piece of feedback from the consulted one or more compliance focal associated with the level of sensitivity associated with the extracted one or more new terms and the level of relevancy associated with the extracted one or more new terms.

20. The computer program product of claim 15, wherein the received corpus of documents includes publications, articles, social media posts, manuals, textbooks, reports or any other form of written materials associated with one or more particular subject matters.
